(19) United States
(12) Patent Application Publication
(10) Pub. No.: US 2005/0053414 A1
(43) Pub. Date: Mar. 10, 2005

(54) Writing instrument

(76) Inventor: Mark G. Collins, St. Ann, MO (US)

Correspondence Address: HARNESS, DICKEY, & PIERCE, P.L.C, 7700 BONHOMME, STE 400, ST. LOUIS, MO, 63105, US

(21) Appl. No.: 10/901,464

(22) Filed: Jul. 27, 2004

Related U.S. Application Data
(63) Continuation of application No. 10/435,218, filed on May 9, 2003, now abandoned.
Application No. 10/435,218 is a continuation-in-part of application No. 10/010,257, filed on Dec. 7, 2001, now Pat. No. 6,612,766.
Application No. 10/010,257 is a continuation-in-part of application No. 09/760,549, filed on Jan. 16, 2001, now abandoned.
Application No. 09/760,549 is a continuation of application No. 09/219,966, filed on Dec. 23, 1998, now abandoned.

(51) Int. Cl. B43K 23/00

(52) U.S. Cl. 401/195

(57) ABSTRACT

A writing instrument having rotatable beads of various shapes and sizes abutting one another so that the beads form logos, designs, words or messages for promotional or advertising purposes. The beads provide an ergonomically pleasing sensation to the user and further provide an element of amusement to the user.

### CROSS-REFERENCE TO RELATED APPLICATIONS

This application is a continuation of application Ser. No. 10/435,218, filed May 9, 2003, which is a continuation-in-part of application Ser. No. 10/010,257, filed Dec. 7, 2001, now U.S. Pat. No. 6,612,766, issued Sep. 2, 2003, which is a continuation-in-part of application Ser. No. 09/760,549, filed Jan. 16, 2001, now abandoned, which is a continuation of application Ser. No. 09/219,966, filed Dec. 23, 1998, now abandoned. The contents of each of the aforementioned patent applications are incorporated herein by reference in their entirety as if fully set forth herein.

### FIELD OF THE INVENTION

This invention relates to the field of writing instruments, and more particularly, relates to a writing instrument having beads positioned about the writing instrument for amusement purposes or as an advertising and promotional device.

### BACKGROUND OF THE INVENTION

Writing instruments, such as pens, are an everyday part of our lives. They remain the most common implements for effecting non-verbal communication. Additionally, writing instruments, such as ball point pens, are frequently utilized in advertising and promotion for businesses. It is believed that several million ballpoint pens are sold each year in the United States alone as promotional give-away items for vendors of various goods and services. Fundraisers of all types, including fundraisers for various educational and religious entities, also utilize the sale of writing utensils to procure funding for various projects. There exists a need to provide a writing instrument, such as a pen or pencil, with a novel means of providing advertising and to promote businesses, groups, ideas, beliefs and displays fanciful messages.

It is well known to provide a writing instrument, such as a pen or pencil, with sleeves or cylindrical members for keeping a calendar. For instance, U.S. Pat. No. 2,445,170 to Gonczi provides a writing instrument having a built-in calendar in a cap, consisting of multiple cylinders on a single axis. The device disclosed by Gonczi records information on interfitting cylinder members and disclosed the information by way of day, month and year (as recorded on separate cylinders) through windows on the outer most cylinder members. However, the Gonczi fountain pen is not adapted to display advertisements or otherwise allow the seller to promote its goods or services or to provide amusement to the user. Moreover, the device disclosed does not allow the seller to provide the writing instrument with various shapes and sizes to aid in promoting the seller's business.

Similarly, U.S. Pat. No. 2,577,259 to Millington and U.S. Pat. No. 2,702,439 to Swenssen disclose devices having calendars on their exterior surfaces and being adapted to hold writing instruments. Like Gonczi, the Millington and Swenssen devices provide cylindrical members, one on top of the other in an interfitting manner, that work in unison to display the day, month and year when the user manipulates the cylinder members into the appropriate positions. As such, these devices are not adapted for, nor do they suggest, advertising or promotion uses. Moreover, both Millington and Swenssen relate to holders of writing utensils where the disclosed devices are fitted over the writing utensil, thus adding additional cost and complexity to the writing instrument itself.

There have been a number of penholder designs employed for the purpose of amusement. For example, U.S. Pat. No. 4,983,062 to Hour relates to a penholder with puzzle blocks whereby a number of blocks with slideable lateral faces are received about a stem that encompasses an ink cartridge. The blocks are arranged such that the user moves the slideable faces between the various rotatable blocks as a puzzle game similar to a RUBICS CUBE©. However, the device disclosed in Hour is relatively complex and costly to manufacture and is not well adapted for use as an advertising or promotional device. Moreover, the Hour device is a penholder, not a writing instrument, again adding to the cost of manufacture by necessitating additional components and assembly expense.

The patent which issued to Du Lude (U.S. Pat. No. 2,357,940) shows a device for counting words and symbols of messages, such as a telegraph message, consisting of a counting mechanism stored in the casing of a writing instrument. The counting mechanism is actuated by depressing the point of the device (i.e., a pen or pencil) adjacent to each word or symbol to be counted and displays the number of words or symbols thus counted through windows on the casing of the device. The Du Lude device is not, however, intended as an item for advertising and promotion or for amusement of the user. Additionally, the counting mechanism disclosed requires a great deal of space, thus making the device rather unwieldy and uncomfortable to the user.

Accordingly, the inventor has recognized that there exists a need to provide a writing instrument that is adapted for advertising, promotion and amusement, esthetically pleasing, simple and inexpensive to manufacture and ergonomically pleasing to the user.

### SUMMARY OF THE INVENTION

In order to overcome the shortcomings of known writing instruments, the present invention has been developed with a number of goals in mind, such as providing a new and improved writing utensil holder which is rugged and simple in construction, pleasing in appearance and in operation, inexpensive to manufacture and can be used to advertise and promote the goods and services of a vendor and provide amusement to its user.

The present invention provides a writing instrument, which comprises a writing member, a nib socket or writing end, a plurality of rotatable indicia, and an end or aft socket. The indicia, nominally beads, are adapted to rotate about the writing member. Each of the rotatable indicia may be selected from the geometric group consisting of spheres, cylinders, cubes, polyhedrons and other shapes, each having a bore through its center line axis for being received about the center line axis of the writing member. The indicia are nominally decorated on their exterior surface with symbols, lettering or numbering, such that, when arranged together about the writing member, the indicia form a logo, spell words, form symbolic messages or present a purely fanciful display. The decorations on each exterior surface of the indicia may be of a different color, or display a different letter, number or symbol to add to the amusement value of the writing instrument. The indicia also provide a second gripping surface for the writing instrument that is ergonomically pleasing to the user.

The present invention serves the purpose of being a low cost writing instrument which, at the same time, provides advertising, promotion, and identification to the seller and amusement to the user.

Other objects or advantages will be apparent or pointed out in the following description.

### BRIEF DESCRIPTION OF THE DRAWINGS

For a better understanding of the present invention, reference should be had to the following detailed description taken in conjunction with the drawings in which:

FIG. 1 is a perspective view showing a new and improved writing instrument with indicia according to the invention.

FIG. 2 is an exploded perspective view of the writing instrument with beads shown in FIG. 1;

FIG. 3 is an exploded perspective view of a second embodiment of the writing instrument of this invention;

FIG. 4 is a perspective view of a further embodiment of the present invention, utilized as a pencil;

FIG. 5 is an exploded perspective view of a writing instrument according to another exemplary embodiment of the invention; and

FIG. 6 is an exploded perspective view of a writing instrument according to another exemplary embodiment of the invention.

Corresponding reference characters identify corresponding elements throughout the several views of the drawings.

### DETAILED DESCRIPTION OF PREFERRED EMBODIMENTS

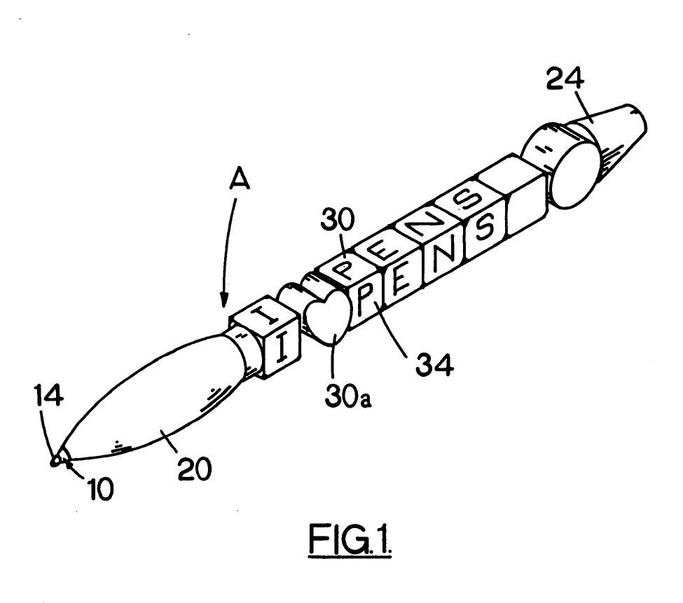

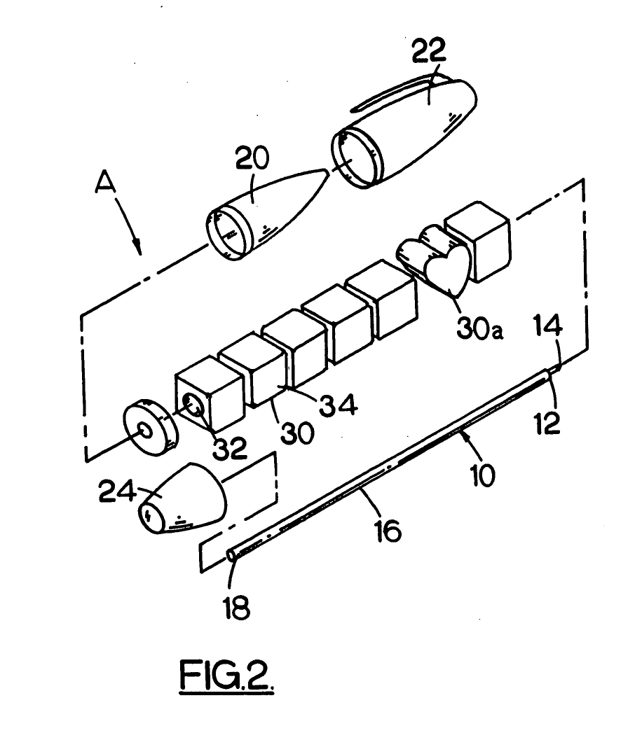

Referring to FIGS. 1-2 of the drawings, a first embodiment of a writing instrument of the invention is designated A, and includes a writing member 10, a nib socket or front element 20, a cap or end socket 22, an aft socket or element 24 and a plurality of rotatable indicia 30.

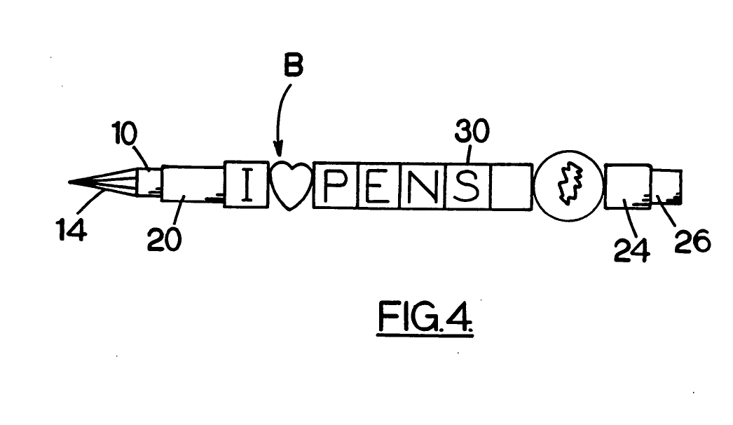

The writing member 10 provides the invention with a means of writing, and can be an ink cartridge, a pencil, a crayon or other writing implement such as a fluorescent marker or the like. In embodiment A of the present invention, writing member 10 is a well-known ballpoint pen having a cylindrical tubular ink reservoir. FIG. 4 shows a second embodiment where the writing member 10 is a pencil.

Indicia 30 are, in essence, bead members of various geometric shapes including spheres, cubes, cylindrical discs, and fanciful shapes including hearts, and well-known shapes of objects such as footballs, basketballs, golf balls and the like. The indicia are preferably made of plastic; however, it will be readily apparent that many other substances with long-wearing properties, such as wood, metal, closed cell foam, ceramics, etc., can be readily substituted. Each of the rotatable indicia 30 is provided with an identical axial through-hole or bore 32 for assembling on the writing member 10 between said nib socket 20 and said aft socket 24, as is more fully discussed below.

As shown in FIG. 1, those indicia 30 shaped as a cube have four exterior surfaces, designated 34. It is conceivable that the exterior surfaces 34 of a number of indicia 30 will be provided with letters of the alphabet or numbers arranged to spell a message, theme, or name. It is also envisioned that the exterior surfaces of indicia 30 will have pictorial representations of various animate and inanimate objects, symbols and logos. Similarly, the indicia can be arranged to display a symbolic message. Those indicia of spherical or ovular shape may have disposed about their surface circumference a variety of letters, numbers, symbols, logos, etc. In addition, either or both the fore and aft elements 20 and 24 can have a decorated exterior surface on which is provided pictorial representations of various animate and inanimate objects, symbols, logos, messages, etc. For example, known silk-screening processes can be used to provide a logo on the nib socket 20. Or for example, stickers or adhesive labels may be applied to the nib socket 20 to decorate the exterior surface of the nib socket 20.

Nib socket 20 is fitted about the head 12 of writing member 10 and provides an initial gripping surface for the writing instrument A. As shown in FIG. 2, the cap 22 is fitted about the nib socket 20 to cover the nib or writing end 14 of writing member 10. A plurality of the rotatable indicia 30 are then fitted about the ink cartridge 16 of writing member 10 in a number so as to sufficiently cover the ink cartridge 16. Aft socket 24 is then fitted to end 18 of writing member 10 so as to fully enclose ink cartridge 16 to prevent accidental blotting or spilling of the ink contained therein. The head 12 of writing member 10 may be smooth (FIG. 2) for a glue or a friction fit with the nib socket or fore element 20. Likewise, the end 18 of writing member 10 may be smooth (FIG. 2) for a glue or a friction fit with the aft socket or element 24.

Indicia 30 can be provided of various sizes depending upon the words, symbol, logo or message to be conveyed. Similarly, a variety of indicia 30 with blank exterior surface can be used to act as spacing between multiple words or character symbols. As noted above, certain indicia 30a can be fashioned as fanciful shapes, such as hearts, to act as words, namely “love,” as shown in FIG. 1. Indicia 30 can also take the form of other well-known shapes, such as footballs, baseballs and golf balls to emphasize a product of the vendor or a theme.

Indicia 30, when arranged about writing member 10, act to form a second gripping surface for the writing instrument A. The shape and size of indicia 30, and their ability to rotate about the writing member 10, provide comfort and an ergonomically pleasing effect to the user. The rotatability of indicia 30 about writing member 10 also provides amusement to the user.

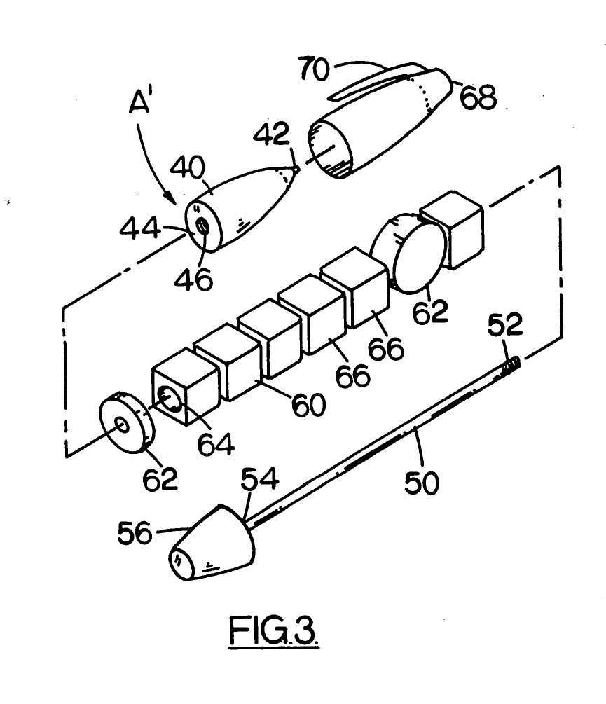

FIG. 3 shows a variation of the writing instrument previously herein described. As shown in this figure, writing instrument A′ includes a nib socket or fore element 40 having a nib or writing end 42 of an ink cartridge and a flat base section 44. Base section 44 can be provided with a threaded vertical bore 46 which is adapted to threadedly engage a threaded rod section 50 as is hereinafter more fully described.

Writing instrument A′ also includes a rod section 50 and a plurality of rotatable shaped indicia 60 and 62. Rod section 50 further includes a first threaded end 52, a second threaded end 54, and an aft socket or element 56. Rotatable indicia 60 and 62 are each provided with a bore 64. Exterior surfaces 66 of indicia 60 and 62 are provided with letters, numbers, or designs as hereinabove described. The indicia 60 and 62 are also of similar shapes and formed of materials as hereinbefore more fully described. In addition, either or both the fore and aft elements 40 and 56 can have a decorated exterior surface on which is provided pictorial representations of various animate and inanimate objects, symbols, logos, messages, etc. For example, known silk-screening processes can be used to provide a logo on the fore element 40. Or for example, stickers or adhesive labels may be applied to the fore element 40 to decorate the exterior surface of the fore element 40.

Adapted for placement over cartridge nib or writing end 42 is cap 68 which may further be provided with a pocket clip member 70. Alternatively, the pocket clip member can instead be attached to the aft element 56. It should be noted that the use of the terms “first” and “second” herein is for identification purposes and not for specifying a particular order or sequence.

Writing instrument A′ is assembled by first placing a sufficient number of rotatable indicia 60 and 62 in an arranged design so as to form an appropriate display on the rod section 50 and then threadedly engaging threaded end 52 and threaded bore 46 by inserting rod section 50 into base section 44. Although the threaded end 54 may be threadedly engaged with a threaded bore (not shown) of the aft socket 56 prior to the placement of the indicia 60 and 62 onto the rod section 50, such is not required. Alternatively, the threaded end 54 may be threadedly engaged with the aft socket or element 56 after the placement of the indicia 60 and 62 onto the rod section 50 and after the engagement of the threaded end 52 with the bore 46. In other embodiments, the rod section 50 may be integral with or be a separate component fixedly attached to the aft element 56, thereby eliminating the step for the user of engaging the end 54 of rod section 50 with the aft element 56.

There are many variations in the construction of writing instrument A′. For example, the ink cartridge 40 within the fore element 40 can be adapted to accept ball pen or fountain pen ink and writing end 42 can be a ballpoint or fountain pen nib. Base section bore 46 can be threaded for threadable engagement or smooth for glue or a friction fit insertion of the rod section 50. Similarly, rod section 50 can be plastic, wood or metal.

FIG. 4 shows an alternative embodiment of the present invention, designated as B, where the writing member 10 is a pencil. Nib socket 20 is fitted over writing member 10 near its writing end 14. Indicia 30 are then threaded onto writing instrument 10 from cap end 18 in sufficient number to spell or depict the desired message. Aft socket 24 is then fitted over end 18 (not shown) of writing instrument 10 to retain indicia 30 about writing instrument 10 and, alternatively, to retain an eraser 26.

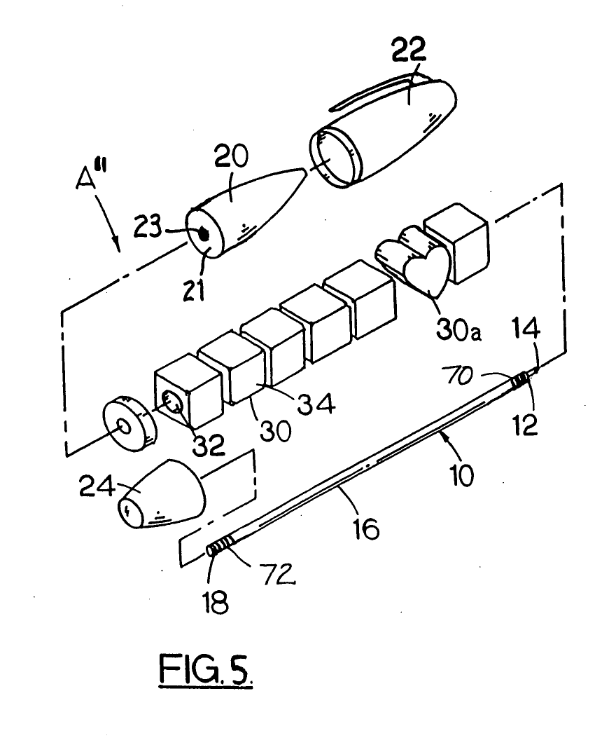

FIG. 5 shows another embodiment of the writing instrument generally designated as A″. As shown, the writing instrument A″ includes a writing member 10, a nib socket or front socket 20, a cap or end socket 22, an aft socket 24 and a plurality of rotatable indicia 30.

The writing member 10 includes a head 12 having a first threaded portion 70 and an end 18 having a second threaded portion 72. The first threaded portion 70 allows the head 12 to be threadedly engaged with a threaded bore 23 defined within a base section 21 of the fore element 20. Alternatively, the bore 23 in the nib socket 20 and the head 12 of writing member 10 may both be smooth for a glue or a friction fit insertion of the head 12 into the nib socket bore 23.

Although the base section 21 is shown to be integral with the nib socket 20, the base section 21 in other embodiments may comprise a separate component that is engaged, for example via an interference fit or with threads, to the nib socket 20. By removing the base section 21, a user is thus able to access the ink cartridge or other writing member 10 within the nib socket 20, for example, to install, replace or remove the writing member 10.

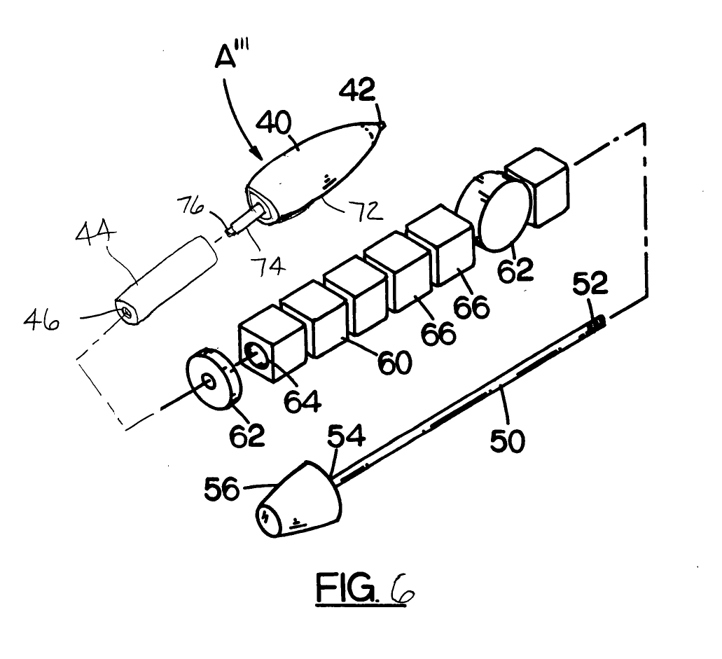

The base section 44 in embodiment A′ is shown in FIG. 3 as being integral with nib socket 40. However, the base section 44 may instead comprise a separate component that is adapted to engage the nib socket 40 as shown for the embodiment A′″ in FIG. 6. Alternatively, the base section 44 may be provided with external threads or grooves that threadedly engage corresponding grooves or threads within the nib socket 40. The removable base section 44 allows a user to access the ink cartridge or other writing member 10 within the nib socket 40, for example, to install, replace or remove the writing member 10. In addition, the removable base section 44 also significantly increases the available space of the writing instrument for decorative, ornamental and/or communicative displays for amusement, advertising, and/or promotional purposes, among other purposes. The exterior surface of the base section 44 may be decorated with pictorial representations of various animate and inanimate objects, symbols, logos, messages, etc. For example, known silk-screening processes can be used to provide a logo on the base section 44. Or for example, stickers or adhesive labels may be applied to the base section 44 to decorate the exterior surface of the nib socket 20 and provide the decorations thereon.

In some embodiments, the removable base section 44 also increases ventilation within the nib socket 40. This, in turn, allows the ink to flow more readily through the ink cartridge.

With further reference to FIG. 5, the second threaded portion 72 allows the end 18 to be threadedly engaged with a threaded bore (not shown) defined within the aft element 24. Alternatively, the bore in the aft element 24 and the end 18 of writing member 10 may both be smooth for a glue or a friction fit insertion of the end 18 into the aft socket bore.

In the particular illustrated embodiment A″, the writing member 10 is a well-known ballpoint pen having a cylindrical tubular ink reservoir. Alternatively, other writing implements (e.g., a pencil, a crayon, a marker, etc.) can also be used for the writing member 10 in embodiment A″.

Writing instrument A″ also includes a plurality of indicia 30 as described above. The indicia 30 are each provided with a through-hole or bore 32 for assembling on the writing member 10 between the nib socket 20 and the aft socket 24 in the manner that will now be described.

Writing instrument A can be assembled by threadedly engaging the head 12 with the nib socket bore 23. Indicia 30 are then arranged onto writing member 10 by threading or sliding the end 18 through the central-bores 32 of the indicia 30. The end 18 is then threadedly engaged with the aft socket bore. In other embodiments, the head 12 of writing member 10 may be integral with or fixedly attached to the nib socket 20 thereby eliminating the initial step of engaging the head 12 of writing member 10 with the nib socket 20.

Alternatively, the writing instrument A″ may be assembled by threadedly engaging the end 18 with the aft socket bore. Indicia 30 are then arranged onto writing member 10 by threading or sliding the head 12 through the central bores 32 of the indicia 30. The head 12 is then threadedly engaged with the nib socket bore 23. In other embodiments, the end 18 of writing member 10 may be integral with or be a separate component fixedly attached to the aft socket 24, thereby eliminating for the user the initial step of engaging the end 18 of writing member 10 with the aft socket 24.

Once the writing instrument A″ is assembled, the indicia 30 provide the writing instrument A″ with a decorative, ornamental and/or communicative display for amusement, advertising, and/or promotional purposes, among other purposes. Preferably, the assembled writing instrument A″ includes a sufficient number of indicia 30 such that the indicia 30 abut one another, with the indicia at the ends abutting the nib and aft sockets 20 and 24.

In some embodiments, the writing instrument may also include a biasing device for resiliently biasing the writing member in an extended or distal direction (i.e., a direction from the aft socket towards the nib socket). In one embodiment, the writing member has a nib that is spring-loaded via a coil spring positioned within the nib socket. The coil spring is engaged with a shoulder defined by a base section (e.g., 21 or 44) removably engaged (e.g., threadedly engaged) with the nib socket (e.g., 20, 40, etc.). The coil spring is further engaged with a shoulder defined by either the writing instrument or by a component coupled to the writing member.

The writing instrument may be further adapted such that rotation of the nib socket or portion thereof causes a nib of the writing instrument to extend outwardly beyond the nib socket, whereas rotation in the opposite direction causes the nib to retract into the nib socket. For example, the embodiment A′″ shown in FIG. 6 is adapted such that rotation of a first portion 72 of the fore element 40 relative to a second portion 74 of the fore element 40 causes the nib 42 to extend outwardly beyond the fore element 40 or retract into the fore element 40, depending on the depending on the direction of the rotation. The base section 44 accommodates the retraction of the nib 42 into the fore element 40 by creating a space between the base section 44 and the second portion 74 of the fore element 40. This space is sufficient for extension of the rear portion 76 when the nib 42 is retracted into the fore element 40.

In view of the foregoing description of the present invention and various embodiments and methods, it will be seen that the several objects of the invention can be achieved and other advantages can be attained.

The embodiments have been described in order to best explain the principles of the invention and its practical application, to thereby enable others skilled in the arts to best utilize the invention in various embodiments and with various modifications as are suited to the particular use contemplated.

As various modifications could be made in the construction and methods herein described and illustrated without departing from the scope of the invention, it is intended that all matter contained in the foregoing description or shown in the accompanying drawings shall be interpreted as illustrative rather than limiting.

The description of the invention is merely exemplary in nature and is in no way intended to limit the invention, its application, or uses. Thus, variations that do not depart from the substance of the invention are intended to be within the scope of the invention. Such variations are not to be regarded as a departure from the spirit and scope of the invention.

1. A writing instrument comprising an ink cartridge having a head and an end, a fore element engaged with the head, an aft element engaged with the end, and one or more indicia rotatably mounted directly on the ink cartridge and retained between the aft element and the fore element, the indicia being arranged on the ink cartridge to form at least one word.

2. A method of assembling a writing instrument comprising selectively arranging and rotatably mounting one or more indicia on a rod section so as to convey a particular theme, and engaging a first end of the rod section with a fore element including a writing member to thereby retain the indicia on the rod section between the fore element and an aft element fixedly attached to a second end of the rod section.

3. The method of claim 2, wherein the one or more indicia are selectively arranged on the rod section to form at least one word.

4. The method of claim 2, further comprising fixedly attaching the aft element to the second end of the rod section.

5. The method of claim 2, further comprising selecting the one or more indicia from a plurality of indicia, and then selectively arranging and rotatably mounting the selected indicia on the rod section.

6. The method of claim 2, wherein engaging the first end of the rod section with a fore element includes threadedly engaging the first end of the rod section with the fore element.

7. The method of claim 2, wherein the one or more indicia are configured consistent with a sports-related theme, and wherein at least one of said indicia comprises a sports ball consistent with the sports-related theme.

8. The method of claim 2, wherein at least one of the one or more indicia comprises at least one of a bead element and a bead.

9. The method of claim 2, wherein at least one of the one or more indicia includes a geometric shape selected from a group of geometric shapes consisting of spheres, spheroids, cylindrical discs, and polyhedrons.

10. The method of claim 2, wherein the one or more indicia abut one another when rotatably mounted on the rod section.

11. A writing instrument comprising a rod section including a first end and a second end, a fore element including a writing member engaged to the first end of the rod section, an aft element fixedly attached to the second end of the rod section, and one or more indicia rotatably mounted directly on the rod section and retained between the aft element and the fore element, the one or more indicia being selectively arranged on the rod section to convey a particular theme.

12. The writing instrument of claim 11, wherein the one or more indicia are selectively arranged on the rod section to form at least one word.

13. The writing instrument of claim 11, wherein the theme comprises a sports-related theme, and wherein at least one of said indicia comprises a sports ball consistent with the sports-related theme.

14. The writing instrument of claim 11, wherein at least one of the one or more indicia comprises at least one of a bead element and a bead.

15. The writing instrument of claim 11, wherein at least one of the one or more indicia includes a geometric shape selected from a group of geometric shapes consisting of spheres, spheroids, cylindrical discs, and polyhedrons.

16. The writing instrument of claim 11, wherein the writing member comprises an ink cartridge having a nib.

17. The writing instrument of claim 11, wherein the one or more indicia abut one another when rotatably mounted on the rod section.

18. The writing instrument of claim 11, further comprising a base section engaged with the fore element, the base section defining a threaded bore for threadedly engaging a threaded portion of the first end of the rod section.

19. The writing instrument of claim 11, wherein the aft element is frustoconical.

20. The writing instrument of claim 11, further comprising a pocket clip member.

21. The writing instrument of claim 20, further comprising a cap adapted for placement over a writing end of the writing member, and wherein the pocket clip is attached to the pocket clip member.

22. A writing instrument comprising an ink cartridge, a fore element, an aft element, and one or more indicia rotatably mounted directly on the ink cartridge and retained between the aft element and the fore element, the indicia being selectively arranged on the ink cartridge to convey a particular theme.

23. The writing instrument of claim 22, wherein the one or more indicia are selectively arranged on the ink cartridge to form at least one word.

24. The writing instrument of claim 22, wherein at least one of the one or more indicia comprises at least one of a bead element and a bead.

25. The writing instrument of claim 22, wherein at least one of the one or more indicia comprises a sports ball.

26. The writing instrument of claim 22, wherein at least one of the one or more indicia includes a geometric shape selected from a group of geometric shapes consisting of spheres, spheroids, cylindrical discs, and polyhedrons.
